(19) United States
(12) Patent Application Publication
(10) Pub. No.: US 2018/0029564 A1
(43) Pub. Date: Feb. 1, 2018

(54) METHOD OF CONTROLLING A REAR WINDOW WIPER SYSTEM OF A VEHICLE

(71) Applicant: GM GLOBAL TECHNOLOGY OPERATIONS LLC, Detroit, MI (US)

(72) Inventors: Daniel P. Carlesimo, Rochester, MI (US); Marcelo V. Lazarini, Clinton Township, MI (US); Regis Errerias, Fundacao (BR)

(73) Assignee: GM GLOBAL TECHNOLOGY OPERATIONS LLC, Detroit, MI (US)

(21) Appl. No.: 15/221,114

(22) Filed: Jul. 27, 2016

(51) Int. Cl. B60S 1/08; B08B 1/00; B60S 1/58

(52) U.S. Cl. CPC B60S 1/0896; B60S 1/583; B08B 1/001

(57) ABSTRACT

A method of controlling a rear wiper system of a vehicle includes determining at least one current vehicle operating parameter with a vehicle controller in response to the rear wiper system being activated. The current vehicle operating parameter may include an on/off status of a front wiper system, a wiper speed of the front wiper system, a ground speed of the vehicle, or some other parameter dependent upon a body style of the vehicle. A delay time for the rear wiper system is defined, with the vehicle controller, based on one or more of the current vehicle operating parameters. The rear wiper system is controlled, with the vehicle controller, to repeatedly actuate the rear wiper system at time intervals separated by the defined delay time. Accordingly, the delay time of the rear wiper system is controlled by the vehicle controller as a function of the current vehicle operating parameters.

### TECHNICAL FIELD

The disclosure generally relates to a method of controlling a rear wiper system of a vehicle with a controller.

### BACKGROUND

Vehicles having a front windshield, i.e., a forward facing window, such as but not limited to cars, trucks, buses, etc., typically include a front wiper system that includes one or more front wiper blades that are operable to wipe the windshield. Some vehicles, such as but not limited to SUV's, cross-over vehicles, buses, station wagons, etc., may also include a rear wiper system having one or more rear wiper blades that are operable for wiping a rearward facing window of the vehicle.

The front wiper systems are typically operable in several different speeds, such as a high constant speed, a low constant speed, or several different delayed or intermittent speeds. These different wiper speeds allow a user to select the wiper speed for the front wiper system that matches the wiping needs. The rear wiper systems are typically only operable in one constant speed, and maybe one delayed or intermittent speed. Accordingly, the limited number of possible wiper speeds for the rear wiper system limit the wiper speed choices of the user, and often may not match current wiping needs of the vehicle for many conditions.

### SUMMARY

A method of controlling a rear wiper system of a vehicle is provided. The method includes determining at least one current vehicle operating parameter with a vehicle controller in response to the rear wiper system being activated. An actuation sequence for the rear wiper system is defined, with the vehicle controller, based on the at least one current vehicle operating parameter. The rear wiper system is then controlled, with the vehicle controller, to repeatedly actuate the rear wiper system at the defined actuation sequence.

A vehicle is also provided. The vehicle includes a forward facing window, and a rearward facing window. The vehicle includes a front wiper system having a front wiper blade that is operable to wipe the forward facing window, and a rear wiper system having a rear wiper blade operable to wipe the rearward facing window. A vehicle controller is coupled to the rear wiper system, and is operable to control actuation of the rear wiper blade. The vehicle controller includes a processor and tangible, non-transitory memory, on which is recorded a rear wiper control algorithm. The processor is operable to execute the rear wiper control algorithm to determine at least one current vehicle operating parameter, define a delay time for the rear wiper system based on the at least one current vehicle operating parameter, and repeatedly actuate the rear wiper system at time intervals separated by the defined delay time.

Accordingly, the vehicle controller is operable to control the operation of the rear wiper system, based on the current vehicle operating parameters. The current vehicle operating parameters may include, for example, whether or not the front wiper system is turned on, or is turned off, a wiper speed of the front wiper system when the front wiper system is turned on, a ground speed of the vehicle, or other parameters dependent on a body style of the vehicle. The vehicle controller uses one or more of these current operating parameters to define a delay time for the rear wiper system, and then controls the rear wiper system to operate the rear wiper blade with the defined delay time for the rear wiper system. In so doing, the vehicle controller provides expanded functionality to the rear wiper system, to provide more wiper speeds for the rear wiper system, without the added cost of a control switch having several different intermittent wiper speeds. Additionally, the method and system described above enable the use of a simple on/off switch to drive multiple rear wiper speeds, from a steady state wiper speed down to a long, intermittent delay wiper speed. This eliminates the need for a 3 or more stage switch, which would typically include, at a minimum, an “on” position, a “first speed” position, and an “intermittent” speed position.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a vehicle showing a front wiper system for a forward facing window, and a rear wiper system for a rearward facing window.

FIG. 2 is a flowchart representing a method of controlling the rear wiper system with a vehicle controller.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

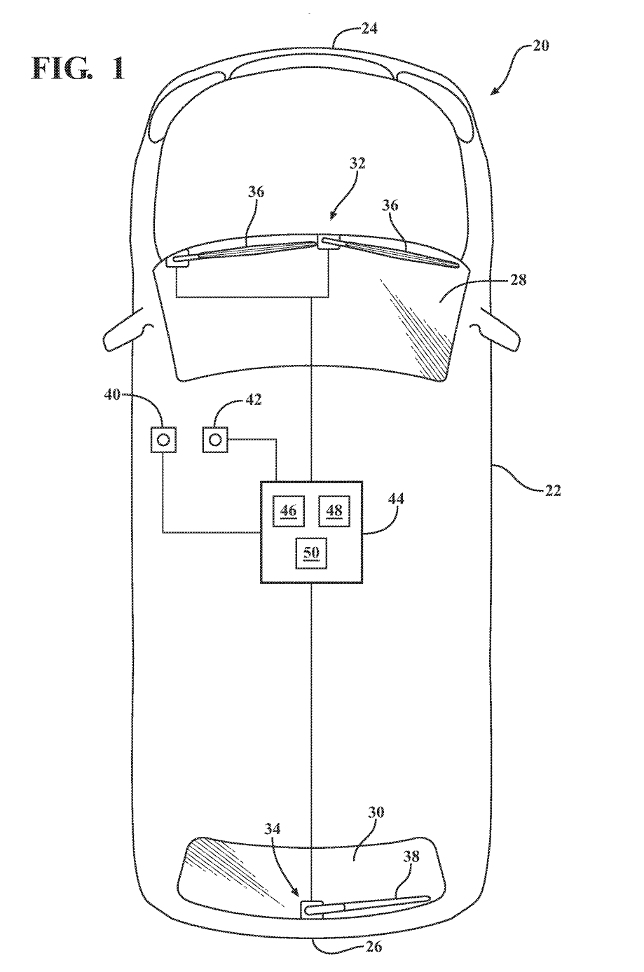

Referring to the Figures, wherein like numerals indicate like parts throughout the several views, a vehicle is generally shown at 20 in FIG. 1. The vehicle 20 may include any type and/or style of vehicle 20, such as but not limited to car, truck, bus, etc.

The vehicle 20 includes a body 22 that extends along a longitudinal axis between a forward end 24 and a rearward end 26. The forward end 24 may be defined as the front end of the vehicle 20, and the rearward end 26 of the vehicle 20 may be defined as the back end of the vehicle 20. The vehicle 20 includes a forward facing window 28 and a rearward facing window 30. The forward facing window 28 is disposed nearer the forward end 24 of the vehicle 20 than is the rearward facing window 30. The rearward facing window 30 is disposed nearer the rearward end 26 of the vehicle 20 than is the forward facing window 28.

A vehicle 20 includes a front wiper system 32 and a rear wiper system 34. The front wiper system 32 includes one or more front wiper blades 36 that are operable to wipe the forward facing window 28. The rear wiper system 34 includes one or more rear wiper blades 38 that are operable to wipe the rearward facing window 30. Both the front wiper system 32 and the rear wiper system 34 may include respective motors, switches connections, gear sets, etc., necessary to move their respective wiper blades for wiping the forward facing window 28 and the rearward facing window 30 respectively, as is known in the art.

The front wiper system 32 may include a front switch 40, which is operable by a user, to turn the front wiper system 32 on or off. Additionally, the front switch 40 may allow the user to select between a plurality of different wiper speeds, depending upon the required wiping needs at that time. For example, the front switch 40 may allow the user to select one of a first wiper speed (e.g., a low wiper speed), a second wiper speed (e.g., a high wiper speed), or one of a plurality of different intermittent wiper speeds. The different intermittent wiper speeds each include a different delay time for the front wiper system 32 as is known in the art. For example, a first intermittent speed may have a delay time of 2 seconds, a second intermittent speed may have a delay time of 4 seconds, a third intermittent speed may have a delay time of 6 seconds, etc.

The rear wiper system 34 may include a rear switch 42, which is operable by the user, to engage the rear wiper system, i.e., to turn the rear wiper system 34 on or off. Typically, the rear switch 42 is an “on/off” switch, that is only capable of turning the rear wiper system 34 on, i.e., engaging the rear wiper system 34, or turning the rear wiper system off, i.e., disengaging the rear wiper system 34. The actuation rate or speed of the rear wiper system 34 is controlled by a rear wiper control algorithm 48, described in detail below. When turned on, the user may select between different options for controlling the rear wiper system 34. For example, the user may select the rear wiper system 34 to operate at a continuous wiper speed, the user may select the rear wiper system 34 to operate at a pre-defined intermittent wiper speed, or the user may select that the wiper speed of the rear wiper system 34 be controlled by a vehicle controller 44 to match the current wiping needs of the rearward facing window 30.

The vehicle controller 44 is coupled to the rear wiper system 34, and is operable to control operation of the rear wiper system 34, including actuation of the rear wiper blade 38 and/or the wiper speed of the rear wiper blade 38.

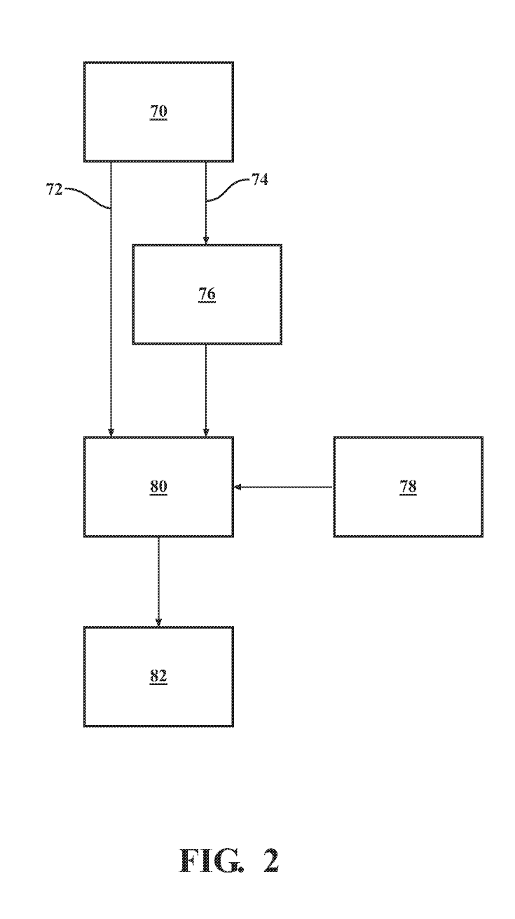

The vehicle controller 44 may include a computer or control module, and may be considered a specialized computer. The vehicle controller 44 may be an independent device, or may be incorporated into another vehicle 20 control system and/or control module. The vehicle controller 44 may include a computer and/or processor 50, and include all software, hardware, memory, algorithms, connections, sensors, etc., necessary to manage and control the operation of the rear wiper system 34. As such, a method, described below and generally shown in FIG. 2, may be embodied as a program or algorithm that is operable on the vehicle controller 44. It should be appreciated that the vehicle controller 44 may include any device capable of analyzing data from various sensors, comparing data, making the necessary decisions required to control the operation of the rear wiper system 34, and executing the required tasks necessary to control the operation of the rear wiper system 34.

The vehicle controller 44 may be embodied as one or multiple digital computers or host machines each having one or more processors 50, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The vehicle controller 44 includes tangible, non-transitory memory 46 on which are recorded computer-executable instructions, including the rear wiper control algorithm 48. The processor 50 of the vehicle controller 44 is configured for executing the rear wiper control algorithm 48. The rear wiper control algorithm 48 implements a method of controlling the rear wiper system 34 described below.

The method of controlling the rear wiper system 34 of the vehicle 20, with the vehicle controller 44, includes determining at least one current vehicle 20 operating parameter in response to the rear wiper system 34 being activated by the user. Accordingly, when the user activates the rear wiper system 34, such as by turning the rear switch 42 to an on position, the vehicle controller 44 automatically determines a current status or value of one or more vehicle 20 operating parameters.

The vehicle 20 operating parameters may include, but are not limited to, an on/off status of the front wiper system 32, a speed of the front wiper system 32, a ground speed of the vehicle 20, or some other parameter based on a body style of the vehicle 20. The user may select which of the current vehicle 20 operating parameters is used to define the delay time for the rear wiper system 34. For example, the user may select that the delay time for the rear wiper system 34 be a function of only the speed of the front wiper system 32, or that the delay time for the rear wiper system 34 be a function of all of the on/off status of the front wiper system 32, the speed of the front wiper system 32, and the ground speed of the vehicle 20. The user may select which of the current vehicle 20 operating parameters be used by the rear wiper control algorithm 48 by inputting the desired selection into an input device coupled to the vehicle controller 44, such as a touch screen information panel, a display information center configuration menu, or other similar device.

As used herein, the on/off status of the front wiper system 32 describes that status as being turned “on” or engaged, or being turned “off” of disengaged. As noted above, the user may activate the front wiper system 32 by turning the front switch 40 to an “on” position, and may deactivate the front wiper system 32 by turning the front switch 40 to an “off” position. Accordingly, the status of the front wiper system 32 is “on” when the front wiper system 32 is active and being used to wipe the forward facing window 28, and the status of the front wiper system 32 is “off” when the front wiper system 32 is not active and not being used to wipe the forward facing window 28.

As noted above, the speed of the front wiper system 32 may include, but is not limited to, a first constant speed, (i.e., a low constant speed), a second constant speed (i.e., a high constant speed), or one of the plurality of different intermittent speeds, with each different intermittent speed having a different delay time. The vehicle controller 44 may determine the on/off status of the front wiper system 32 and/or the speed of the front wiper system 32 in any suitable manner. For example, the vehicle controller 44 may be linked to the front switch 40 and capable of sensing or otherwise determining the position of the front switch 40, and therefrom deriving the on/off status of the front wiper system 32 and the selected or desired wiper speed of the front wiper system 32.

Referring to FIG. 2, the step of determining the on/off status of the front wiper system 32 is generally indicated by box 70. The “off” status is generally indicated at 72. The “on” status is generally indicated at 74. If the vehicle controller 44 determines that the status of the front wiper system 32 is “on”, then the vehicle controller 44 determines the wiper speed of the front wiper system 32, generally indicated by box 76.

The vehicle controller 44 may determine the ground speed of the vehicle 20 in any suitable manner. The ground speed of the vehicle 20 is calculated, sensed, or otherwise determined for many different control operations of the vehicle 20, and is generally available through vehicle 20 communications systems. For example, the vehicle controller 44 may query a speed control system to determine the ground speed of the vehicle 20. It should be appreciated that the vehicle controller 44 may alternatively be linked to a speed sensor that is operable to sense the speed of the vehicle 20. The step of determining the ground speed of the vehicle 20 is generally indicated by box 78 in FIG. 2.

In order to simplify the determination of the delay time for the rear wiper system 34, the ground speed of the vehicle 20 may be classified into one of a plurality of different ground speed ranges. For example, the vehicle controller 44 may have five different ground speed ranges. The vehicle controller 44 would classify the current ground speed of the vehicle 20 into one of the five different ground speed ranges that it falls. For example, if the ground speed is 75 kph, and the ground speed ranges include a first range of between 0 kph and 10 kph, a second range of between 10 kph and 50 kph, a third range of between 50 kph and 90 kph, a fourth range of between 90 kph and 130 kph, and a fifth range of greater than 130 kph, then the vehicle controller 44 would classify the current ground speed in the third speed range. The vehicle controller 44 may then use the specific speed range that the ground speed of the vehicle 20 is classified into, instead of the actual ground speed of the vehicle 20, in order to define the delay time for the rear wiper system 34.

Once the vehicle controller 44 has determined a status and/or value for each of the current vehicle 20 operating parameters, then the vehicle controller 44 defines an actuation sequence for the rear wiper system. The step of defining the actuation sequence for the rear wiper system 34 is generally indicated by box 80 in FIG. 2. The actuation sequence may be defined as the frequency or rate at which the rear wiper blades 38 are actuated or moved. The actuation sequence may be defined in any suitable manner. For example, defining the actuation sequence may include defining a delay time for the rear wiper system 34. The vehicle controller 44 defines the delay time for the rear wiper system 34 based on the current vehicle 20 operating parameters. Accordingly, the delay time for the rear wiper system 34 is a function of the current vehicle 20 operating parameters. For example, assuming that the current vehicle 20 operating parameters include the on/off status of the front wiper system 32, the wiper speed of the front wiper system 32, and the ground speed of the vehicle 20, then the delay time for the rear wiper system 34 is defined as a function of the on/off status of the front wiper system 32, the wiper speed of the front wiper system 32, and the ground speed of the vehicle 20.

The vehicle controller 44 may define the delay time for the rear wiper system 34 in any suitable manner. For example, the vehicle controller 44 may include a look-up table stored in the memory 46 of the vehicle controller 44. The look-up table correlates the current vehicle 20 operating parameters to a specific value of the delay time for the rear wiper system 34. Accordingly, the vehicle controller 44 may reference the look-up table, using the current vehicle 20 operating parameters as inputs, and obtain an output from the look-up table that is the delay time for the rear wiper system 34. As such, the lookup table may correlates the on/off status of the front wiper system 32, the wiper speed of the front wiper system 32, and the ground speed of the vehicle 20, to the desired value of the delay time for the rear wiper system 34, for the current vehicle 20 operating parameters.

Alternatively the vehicle controller 44 may define the delay time for the rear wiper system 34 by solving an equation, stored in the memory 46 of the vehicle controller 44. The equation would correlate the current vehicle 20 operating parameters to a specific value of the delay time for the rear wiper system 34. Accordingly, the vehicle controller 44 may solve the equation, using the current vehicle 20 operating parameters as inputs, and obtain an output from the equation that is the delay time for the rear wiper system 34. As such, the equation may correlate the on/off status of the front wiper system 32, the wiper speed of the front wiper system 32, and the ground speed of the vehicle 20, to the desired value of the delay time for the rear wiper system 34, for the current vehicle 20 operating parameters. The equation may be defined in any suitable manner known to those skilled in the art.

It is contemplated that the look-up table and/or equation used to define the delay time for the rear wiper system 34 may be dependent upon a body style of the vehicle 20, and the output values of the delay time of the rear wiper system 34 may be specific to and based on the specific body style of the vehicle 20. If the look-up table and/or equation are based on the body style of the vehicle 20, then it should be appreciated that the delay time for the rear wiper system 34 is also a function of the body style of the vehicle 20. It is contemplated that the vehicle controller 44 may include a plurality of different look-up tables or equations stored in the memory 46 of the vehicle controller 44. Each of the plurality of different look-up tables or equations may define values for the delay time for the rear wiper system 34 based on a different body style. The user may then select, via the input device of the vehicle 20, which one of the different look-up tables or equations the vehicle controller 44 uses to define the delay time for the rear wiper system 34.

The delay time for the rear wiper system 34 may be defined to equal any time period, including but not limited to a delay time of zero seconds. For example, the delay time may be defined to equal a time period of between zero seconds and ten minutes or longer. It should be appreciated that if the delay time is defined to equal a time period of zero seconds, then the rear wiper system 34 would operate on a continuous, non-interrupted basis. Alternatively, for example, the delay time may be defined to equal a time period of 10 seconds, in which case the rear wiper blade 38 is actuated once every 10 seconds.

Once the vehicle controller 44 has defined the actuation sequence, e.g., the delay time for the rear wiper system 34, then the vehicle controller 44 controls the rear wiper system 34 to repeatedly actuate the rear wiper system at the defined actuation sequence, e.g., actuate the rear wiper system 34 at time intervals separated by the defined delay time. The step of controlling the rear wiper system 34 is generally indicated by box 82 in FIG. 2. The vehicle controller 44 controls the rear wiper system 34 to engage, such that the rear wiper moves with the passing of each time interval, with each time interval being the defined delay time that is based on the current vehicle 20 operating parameters. The vehicle controller 44 may control the rear wiper system 34 in any suitable manner. For example, the vehicle 20 may control the rear wiper system 34 by selectively and automatically turning the rear wiper system 34 on and off at the appropriate time delay to provide the repeated actuation of the rear wiper system 34 at the defined delay time.

By controlling the rear wiper system 34 with the vehicle controller 44, using the rear wiper control algorithm 48, the delay time for the rear wiper system 34 may be altered between several different values, without the need for a complicated control switch. The above described method improves the functionality of the rear wiper system 34 to satisfy varying wiping needs of the rearward facing window 30, without adding expensive hardware to the vehicle 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of controlling a rear wiper system of a vehicle, the method comprising:
determining at least one current vehicle operating parameter with a vehicle controller in response to the rear wiper system being activated, wherein the at least one current vehicle operating parameter includes a ground speed of the vehicle;
classifying the ground speed of the vehicle into one of a plurality of different ground speed ranges;
defining an actuation sequence for the rear wiper system, with the vehicle controller, based on the specific ground speed range that the ground speed of the vehicle is classified into;
controlling the rear wiper system, with the vehicle controller, to repeatedly actuate the rear wiper system at the defined actuation sequence.

2. The method set forth in claim 1 wherein defining the actuation sequence includes defining a delay time.

3. The method set forth in claim 2 wherein controlling the rear wiper system to repeatedly actuate the rear wiper system at the defined actuation sequence includes controlling the rear wiper system to repeatedly actuate the rear wiper system at time intervals separated by the defined delay time.

4. The method set forth in claim 3 wherein determining the at least one current vehicle operating parameter includes determining at least one of an on/off status of a front wiper system, a speed of the front wiper system, and a ground speed of the vehicle.

5. The method set forth in claim 4 wherein defining the delay time for the rear wiper system includes referencing a look-up table that relates the at least one current vehicle operating parameter to the delay time for the rear wiper system.

6. The method set forth in claim 5 wherein the look-up table is dependent upon a body style of the vehicle.

7. The method set forth in claim 4 wherein defining the delay time for the rear wiper system includes solving an equation that relates the at least one current vehicle operating parameter to the delay time for the rear wiper system.

8. The method set forth in claim 7 wherein the equation relates the delay time for the rear wiper system to a body style of the vehicle.

9. The method set forth in claim 1 wherein determining the at least one current vehicle operating parameter includes determining an on/off status of a front wiper system of the vehicle.

10. The method set forth in claim 9 wherein determining the at least one current vehicle operating parameter includes determining a wiper speed of the front wiper system when the status of the front wiper system is determined to be on.

11. The method set forth in claim 10 wherein determining the wiper speed of the front wiper system includes determining the speed of the front wiper system to be one of a first constant speed, a second constant speed, or one of a plurality of different wiper speeds.

12. The method set forth in claim 11 wherein each of the plurality of different wiper speeds are defined by a different delay time for each respective wiper speed.

13. (canceled)

14. (canceled)

15. The method set forth in claim 2 wherein defining the delay time for the rear wiper system includes referencing a look-up table that correlates an on/off status of a front wiper system, a wiper speed of the front wiper system, and a ground speed of the vehicle, to the delay time for the rear wiper system.

16. The method set forth in claim 15 wherein the look-up table is defined based on a body style of the vehicle.

17. The method set forth in claim 16 wherein the controller includes a plurality of different look-up tables stored in a memory, with each of the plurality of different look-up tables defined based on a different body style, and wherein a user selects which one of the plurality of different look-up tables the controller uses to define the delay time for the rear wiper system.

18. The method set forth in claim 2 wherein defining the delay time for the rear wiper system is a function of an on/off status of a front wiper system, a wiper speed of the front wiper system, a ground speed of the vehicle, and a body style of the vehicle.

19. A vehicle comprising:
a forward facing window;
a front wiper system having a front wiper blade operable to wipe the forward facing window;
a rearward facing window;
a rear wiper system having a rear wiper blade operable to wipe the rearward facing window;
a vehicle controller coupled to the rear wiper system and operable to control actuation of the rear wiper blade, the vehicle controller including a processor and tangible, non-transitory memory, on which is recorded a rear wiper control algorithm, wherein the processor is operable to execute the rear wiper control algorithm to:
determine at least one current vehicle operating parameter, wherein the at least one current vehicle operating parameter includes a ground speed of the vehicle;
classifying the ground speed of the vehicle into one of a plurality of different ground speed ranges;
define a delay time for the rear wiper system based on the specific ground speed range that the ground speed of the vehicle is classified into; and
repeatedly actuate the rear wiper system at time intervals separated by the defined delay time.

20. The vehicle set forth in claim 19 wherein the rear wiper control algorithm defines the delay time for the rear wiper system based on a function of an on/off status of a front wiper system, a wiper speed of the front wiper system, a ground speed of the vehicle, and a body style of the vehicle.
